(19) United States
(12) Patent Application Publication
(10) Pub. No.: US 2007/0244219 A1
(43) Pub. Date: Oct. 18, 2007

(54) PRINTING INKS WITH PROPERTY ENHANCING MICROCAPSULES

(75) Inventors: Utpal R. VAIDYA, Maple Grove, MN (US); Gene Meier, Mound, MN (US); Roman T. Knipp, Shafer, MN (US)

Correspondence Address: HAMRE, SCHUMANN, MUELLER & LARSON, P.C., P.O. BOX 2902, MINNEAPOLIS, MN, 55402-0902, US

(73) Assignee: DataCard Corporation, Minnetonka, MN (US)

(21) Appl. No.: 11/691,833

(22) Filed: Mar. 27, 2007

Related U.S. Application Data
(60) Provisional application No. 60/786,412, filed on Mar. 27, 2006.

(51) Int. Cl. C09D 11/02; C09D 11/00; C09D 11/04; C09D 11/08; C09D 11/14

(52) U.S. Cl. 523/160; 106/31.27; 106/31.6; 106/31.33; 106/31.65; 106/31.41; 106/31.73; 106/31.37; 106/31.69; 106/31.68; 106/31.36; 106/31.53; 106/31.82; 523/161

(57) ABSTRACT

Improved printing inks that provide selectively enhanced properties when applied to substrates. In particular, the improved inks use microcapsules to improve the quality, durability, and/or security of printed inks on substrates, for example identification documents. The microcapsules contain property enhancing chemical components that can be released from the capsules before, during or after printing is completed. The property enhancing components bring about a physical interaction and/or chemical reaction at the ink-substrate interface, in the print ink composition, and/or in the print ink surface, which may result for instance in at least one of improved adhesion, abrasion resistance, chemical resistance, and cohesive strength of the printed ink.

The present application draws priority from U.S. Provisional Patent Application Ser. No. 60/786,412, filed Mar. 27, 2006 and entitled “PRINTING INKS WITH PROPERTY ENHANCING MICROCAPSULES,” and which is incorporated herewith by reference in its entirety.

### FIELD

This disclosure relates to improved printing inks, particularly print ink compositions for use on various identification documents, where the print ink compositions have improved properties, such as enhanced durability and/or security.

### BACKGROUND

Many printing technologies that are used to print on identification documents, such as plastic cards like identity cards, credit cards, and driver's licenses, and passports, provide a low level of durability in regular usage of the documents. Printing technologies that suffer from this deficiency include, but are not limited to, thermal printing, dye diffusion thermal transfer (D2T2) printing, ink jet printing, indent printing and embossing followed by topping of the embossed print.

The deficiencies in these printing technologies often reside in the inks that are used. The starting form of the inks may have limitations, in terms of their chemical and physical nature, that restrict such inks to be able to print with these technologies. Technologies that involve liquid inks, such as ink jet printing, have restrictions on viscosities, corrosiveness, the chemical nature of ingredients, stability etc. Other technologies that use ribbons for printing, such as thermal printing, D2T2, indent printing and emboss/top printing, have restrictions on ink coating thickness, ink stickiness or tack, opacity, dryness, filminess, release, shelf life etc.

More commonly, the properties that allow easier printing tend to cause low durability, and vice-versa, the properties that allow more durability such as tougher ink coatings, crosslinked inks, high strength and high molecular weight resins, etc. tend to hinder the ease and quality of printing.

Another example is the current indent ribbons used during indent printing of credit cards. The indent printing process typically occurs with cold transfer ribbon and indent punches. As a punch impacts the card surface through the ribbon, ink transfers from the ribbon to the intended area of the card. This process is somewhat similar to a type-writer mechanism. For the ink to transfer from the ribbon to the card during indent printing, the ribbon ink coating is preferably sufficiently thin, weak and soft. Although the ink may transfer to the indented area of the card, the ink tends to wear off rather easily after time and during usage, rendering the indent print illegible. Similar drawbacks in durability may be faced with other print technologies.

Another problem faced by inks used in indent printing is the difficulty of conventional inks to adhere to commonly used identification document substrates, for example a plastic such as polyvinyl chloride. In the case of a plastic card, such as a credit card, indent printing is typically performed on the signature panel that is present on the back of many of these cards. The signature panel is made of a material that is different than the remainder of the card substrate. The ink used in the indent printing is developed to adhere to the material of the signature panel. For example, the signature panel usually is a more porous and absorptive material, such as paper or ink receptive coating, than the material of the card substrate, such as polyvinyl chloride. As a result, such inks adhere to the signature panel better than the remainder of the card substrate.

However, there are increasing requirements to employ indent printing outside of the signature panel area and directly onto the plastic card substrate. In such cases, conventional indent printing inks, which are developed to adhere to the signature panel material, may not adequately adhere to the card substrate, thereby providing low durability.

Similar drawbacks may be experienced with other print technologies.

### SUMMARY

This invention describes a novel concept and method to improve durability and security of printing without adversely affecting the key ink properties that are critical for ease of printing, quality of printing and storage and handling of inks. Improved print ink compositions are described that provide selectively enhanced properties when applied to substrates. In particular, the improved ink compositions use microcapsules to improve the durability of printing on substrates. The improved print ink compositions can be used on a number of substrates, for example, various identification documents to provide improved properties, such as enhanced printing durability and increased security against alteration or fraud.

As some examples, such identification documents can include plastic cards, such as identity and financial cards like driver licenses, debit, and credit cards, or other identity documents as national identification cards and passports. Other examples in which the inks described herein can be used include documents such as phone cards and the like, or other paper documents, or may include other documents that bear information unique to a card holder and/or other card or document information.

The improved ink compositions use microcapsules that contain property enhancing chemical components. The property enhancing component(s) are enclosed in the microcapsules and are released at a desired time from the capsules before, during or after the printing is completed. When released, the property enhancing components can bring about a physical interaction and/or chemical reaction at the ink-substrate interface and/or in any part of the printed ink, resulting in enhanced properties, such as print durability or security. Some notable property enhancements of the printed ink include improved adhesion, toughening, abrasion resistance, chemical resistance, cohesive strength, color change etc.

The use of microcapsules prevents the premature interaction of the enhancing chemical with the ink, such as during ink and/or ribbon production and/or storage. That is, the use of microcapsules can allow the desired enhancing properties to be restrained before actually being used to enhance printing ease and/or quality. The release of the components residing in the microcapsules into the ink may be brought about at the desired time with the help of various mechanisms suitable for releasing such components. As some examples only, the components in the microcapsules may be released by impact, pressure, shear, heat, radiation, laser, etc. and combinations thereof.

### DRAWINGS

FIG. 1 illustrates a schematic cross-section view of one embodiment of a print ink composition, with the composition supported by a carrier.

FIG. 2 illustrates a schematic cross-section view of another embodiment of a print ink composition, with the composition supported by a carrier.

FIG. 3 illustrates a schematic cross-section view of yet another embodiment of a print ink composition, with the composition supported by a carrier.

FIG. 4 illustrates a schematic view of another embodiment of a print ink composition, with the composition including ink and microcapsules mixed together without a carrier.

FIG. 5A illustrates a schematic top view of yet another embodiment of a print ink composition, with the composition supported by a carrier that includes support areas without ink composition.

FIG. 5B illustrates a schematic top view of another embodiment of a print ink composition, showing a plurality of print ink compositions on a single carrier with multiple blank support areas without the print ink composition.

FIG. 5C illustrates a partial cross section of the print ink composition shown in FIG. 5B.

FIG. 6 illustrates a schematic cross-section view of yet another embodiment of a print ink composition, and showing an embodiment of an adhesive layer and a release layer.

FIG. 7 illustrates yet another embodiment of a print ink composition, with the composition supported by a carrier.

FIG. 8 illustrates yet another embodiment of a print ink composition, with the composition supported by a carrier.

### DETAILED DESCRIPTION

Improved print ink compositions are described that use microcapsules to provide selectively enhanced properties, for example improved adhesion, abrasion resistance, chemical resistance, and cohesive strength of the printed ink, such as when applied to print substrates. As used herein, the term “microcapsules” is intended to include capsules or other shell-like enclosures. The size of the microcapsules may be, but is not limited to, about 1 nanometer to about 200 microns in diameter when spherical, or in its largest dimension if the capsule is not spherical. It will be appreciated that the microcapsules are not limited to any size and/or shape. It further will be appreciated that the microcapsule size and/or shape may vary accordingly and may depend upon the selectively enhanced property (or properties) to be achieved, the print technology being used, and the end use of the document having the printing ink applied thereon.

Substrates with which the improved print ink compositions can be used include, but are not limited to, various identification documents. As some examples, such identification documents can include plastic cards, such as identity and financial cards like driver licenses, debit, and credit cards, or other identity documents as national identification cards and passports. Other examples in which the ink compositions described herein may be used include documents such as phone cards and the like or other paper documents, or may include other documents that bear information unique to a card holder and/or other card or document information. When the substrate is an identification document, the ink compositions can provide improved properties, such as enhanced durability and security of the ink, on the identification document. As some examples the substrate material can be made up of plastic, paper, coated paper, synthetic paper, glass, fabric, metal inorganic mater or cellulosic matter. The substrate may also be coated, painted plated, or surface treated before or after the printing.

The microcapsules preferably contain at least one property enhancing chemical component to enhance the properties of the ink and/or enhance the interaction between the ink composition and the substrate. The property enhancing component(s) is enclosed in the microcapsules and is released from the capsules before, during or after the printing is completed. It will be appreciated that any of the components used in the microcapsules may be present in pure form, as a solution, as a dispersion, as an emulsion, or as a mixture with other inert components. When released, the property enhancing component can bring about a physical interaction and/or chemical reaction at the ink-substrate interface and/or within the ink composition and/or solely on the exposed surface of the printed ink, resulting in one or more enhanced properties, such as print durability on the substrate. As an example, when the property enhancing component(s) are released, the property enhancing components can physically interact and/or chemically react with each other, the ink material, and/or the substrate. Other factors such as air, heat, moisture, UV or other radiation may be employed to bring about the desired interaction of the property enhancing component. As another example, the property enhancing components in the microcapsules can physically interact with the substrate, such as in the example of an adhesive released to facilitate adherence to the substrate.

Other exemplary property enhancements that can result from the property enhancing component(s) can include, but are not limited to, improved adhesion, abrasion resistance, chemical resistance, moisture resistance, cohesive strength and visual quality of the printed ink, light fastness, tamper evidence and security of the print against alteration or fraud. Security enhancement may include but not limited to release of a color, change of color, release of photo chromic, UV fluorescing, phase change, or temperature sensitive components before, during or after printing or during print altering attempts. Such enhancement may also lead to self destruction of the printing upon document alteration attempts. Property enhancements may also be achieved with respect to visual quality of the ink, including properties such as but not limited to brightness, color, and brilliance.

The use of microcapsules prevents the premature interaction of the property enhancing component with the ink or other components during ink or ribbon production as well as during storage, so as to allow the desired properties to be maintained and preserved before use. It is one desire that the microcapsules are retained within the ink without interaction between the property enhancing component(s) and the ink or other components for a desired length of time prior to printing the ink. For example, the microcapsules can be designed to remain intact within the ink for up to about 1-7 years absent printing of the ink. That is, in one embodiment, the microcapsules themselves act as the preservation capsule.

The release of the property enhancing component(s) from the microcapsules into the ink may be brought about at the desired time with the help of any suitable mechanism for releasing such as but not limited to impact, pressure, shear, heat, radiation, laser, etc. and combinations thereof, to break the microcapsules and release the property enhancing component(s). In one embodiment, breaking of the microcapsules to release the property enhancing component(s) occurs during the act of printing and/or subsequent to printing.

Before turning to some examples of components used for the ink and microcapsules, it will be noted that commonly used inks usually include colorants, a resin to bind to the colorants, and additives. When the ink is in the ribbon form, it is typically produced by applying an ink solution composed of the colorant, resin and additives, to a carrier. The ink is then dried to form a coating on the carrier. The ink ribbon may also have other layers(s) such as but not limited to a release layer, adhesive layers, sizing coats, primers, wear coat, back coats etc. It will be appreciated that such additional layers may be disposed between the ink and carrier or after the ink has been disposed on the carrier. Such a coated carrier may then be suitably converted into a desired form for use in a printer.

When a carrier is used, it may be chosen based on the end requirements desired. One example of a material for the carrier is a polyester film. Polyesters, such as but not limited to, poly(ethylene terephthalate), poly(butylene terephthalate) and poly(ethylene naphthalate) can be among the most favored material for the carrier. Other substances may be employed as the material for the carrier. Such materials may include but are not limited to polyolefins, polyamides, polyimides, polyethers, polycarbonates, poly(vinyl chloride), polyfluoride, a cellulosic material, acrylics, urethanes, acetates, copolymers thereof, papers, release coated papers etc. may be used for carrier. It will be appreciated that the carrier will have the necessary thermal stability, heat conductivity, mechanical strength, thickness and surface properties that are required for a chosen print technology. As noted, additional layers may be added to the carrier such as a back coat or a release coat to make the carrier more print technology friendly.

The following describes some examples of components for an ink material and microcapsules in print ink compositions, in which commonly used inks may be improved with the use of such microcapsules having property enhancing component(s) therein.

The ink material includes a colorant(s), a resin to bind the colorant(s), an ink vehicle, and any number of additives and processing agents. The colorant may include but is not limited to pigments or dyes of differing color, organic or inorganic material, color shift inks, metallic inks, security inks such as tagants which can provide a security feature for identifying personalized documents, reflective inks, reflective beads, color shift inks, fluorescent inks, and any combination of such materials. It will be appreciated that the term “ink” will be construed broadly as including color or not including color, such as a clear coat material that may be applied as the ink material or in conjunction with the ink material. In one embodiment, the colorless inks may include varnishes, topcoats, clear coats, primers or adhesives.

Examples of resins may include but are not limited to acrylics, vinyls, polyester, polyamides, polyimides, polyolefins, hydrocarbons, alkyds, natural and synthetic materials, rubbers, polyurethanes, epoxies, urea, urea formaldehydes, acetates, poly vinyl alcohols, copolymers, polyols, monomers, waxes, silicones, a cellulosic material, and any combination thereof.

The ink vehicle may be a solvent such as but not limited to water, organic solvents, oils, monomers, plasticizers and mixtures thereof. Any additives for the ink material may include but are not limited to surfactants, plasticizers, de-foamers, lubricants, waxes, tackifiers, stabilizers, antioxidants and combinations thereof.

The microcapsules include at least one property enhancing component. Typically, the property enhancing component is at least one of a non-reactive component or a reactive component and may include combinations of both. The non-reactive component can physically enhance a particular property of the ink material and/or enhance the interaction of the ink material with the substrate it is applied to or may bring about a visual change for security. The reactive component may chemically react with the ink material, the ink component, and/or other microcapsule components or with air, heat and/or radiation, so as to enhance a particular property of the ink material and/or enhance the interaction of the ink material with the substrate. It will be appreciated that two or more reactive components and/or non-reactive components may be contained in separate capsules. When released, they can respectively interact and/or react with each other or with other components of the ink material. These microcapsules may be present in any layer/layers of the total print ink composition.

The size of any microcapsule may be about 1 nanometer to 200 microns in diameter in the case of spherical capsules or in its largest dimension in the case of non-spherical capsules. It will be appreciated, however, that such range is merely exemplary only as other sizes and shapes may be employed as suitable and/or necessary for encapsulating the desired property enhancing components and for use in a desired ink application process. It further will be appreciated that the size of microcapsule may depend on a number of factors, such as the means used to rupture the microcapsules, the form of ink, the properties of the microcapsule wall material, etc.

In the example of a coated ribbon the average microcapsule size may be desired to be less than the coating thickness. For instance, a printer ribbon with ink thickness of 12 microns may have a maximum average microcapsule size of 12 micron. The ink particle size and microcapsule size can also depend on the print resolution desired. For finer resolution, finer microcapsule sizes may be used. In yet another example, an impact printer may select the microcapsule size to get maximum rupture at the impact force of the printer.

In yet another example, where wall thickness is a relevant factor of the microcapsule, thicker walls tend to have better stability of the encapsulant such as in environmental extremes. In such a configuration, thicker walls may then require larger microcapsules. While thicker walled microcapsules can be more difficult to break with pressure, smaller microcapsules may also be difficult to break with pressure/impact. In the example, where pressure is the mode by which the microcapsules are to be broken, then a balance may be necessary between microcapsule size and wall thickness used. In yet another example, ink coating thickness can also help determine microcapsule size. For instance, if a 12 micron thick dry ink coating thickness is desired, then the largest microcapsule size would be about 12 microns. It will be appreciated that a variety of thicknesses may be employed for an ink coating, however, thicker ink coats may be prone to flakiness and poor edge definition on imprinted characters. Thus, microcapsule size, wall thickness and material will have to be correctly chosen to get the maximum benefit of the property enhancing component for any specific application in which they are used.

In one embodiment, the microcapsule includes a shell material, such as but not limited to acrylic, polyamide, polyurethane, vinyl, acrylamide, urea-formaldehyde, epoxy, phenolics, polystyrene, polyurea, rosin, starch, gluten, cellulosic, gelatin, or combinations thereof. It will be appreciated that the microcapsules may be produced by a variety of materials known in the art, and that one of skill in the art would be able to select the proper shell material for use to encapsulate any of the novel constituents described herein.

For example, in the arena of liquid encapsulation, two methods, urea formaldehyde and gelatin capsules, developed in the 1950's and 1960's, are still widely used. Some well known examples include 3M's Scratch and Sniff products and the encapsulated ink used in carbonless paper. In these cases, the product consists of a core of non-water miscible liquid material and a shell of urea formaldehyde or cross linked gelatin. Microcapsules prepared in this manner can be as small as 8 microns with up to 85% liquid fill in the capsule. The liquid is released by physically rupturing the shell by pressure, shear or heat. Fill materials include oils, waxes, hydrocarbon solvent-based inks and resins.

As some further examples, methods for preparing microencapsules are disclosed in, for example, U.S. Pat. Nos. 4,087,376, 4,001,140, 4,273,672, 5,961,804, 6,375,872, 6,592,990. Aveka Inc. in Woodbury, Minn. is one such manufacturer of these microencapsulants. Aveka Inc. is also able to produce microencapsulates by other processing such as prilling and spray drying. Less fill can be accommodated with these methods and the fill is dispersed throughout the particle rather than in a core/shell configuration. There are other companies such as Microtek Laboratories and Ronald T. Dodge Company of Dayton, Ohio and Thies Technology of Henderson, Nev., who specialize in producing microcapsules for varied applications.

It will be appreciated that the capsule wall material will be chosen such that it does not react with or dissolve in the encapsulated property enhancing material. It further will be appreciated that the capsule material should also be resistant to the chemicals or processing parameters such as heat pressure shear etc. of ink production in all its forms such as liquid, ribbons etc. It will also be appreciated that once the microcapsules are broken, the material of the microcapsule wall may remain with the printed ink composition as an inert filler.

In one embodiment, the concentration of microcapsules with respect to the ink material in a print ink composition can depend on the capsule size, type of ink material used, type of enhancing compound used and the desired or targeted enhancement, the print technology, and any other available conditions like heat, radiations, pressure, and storage time. The concentration may vary between about 95% and about 1%.

As another example, the microcapsule concentration can be between 10-50%. In certain applications, any more than this and the ink could lose opacity making it undesirable, while any less than 5% may be too small of an amount to have an effect, unless it was for the sole purpose of adding a tagant or other trace compound for security. In such configurations as adding a tagant or other trace compound for security, a concentration of about 0.2% or less could be sufficient. It will be appreciated that these concentrations may be varied outside the above-mentioned range depending on the application.

As yet another non-limiting example, the type of ink applied can require different microcapsule concentrations. For instance, an indent ribbon ink applied strictly by impact can require different capsules and amounts to attain durability than, for example, a topping foil, which is applied to raised characters by heat and pressure.

In one embodiment, examples of security enhancement materials that may be used in the microcapsules include but are not limited to leuco dyes, UV fluorescing agents, photochromic dyes and/or phase change polymers. Using a security enhancement material can allow for the use of less tagant material to accommodate the end security enhancing result desired. Furthermore, using such security enhancing material can enable the tagant material to be disposed to a particular layer of the coated film.

Some examples of a non-reactive enhancing components enclosed in microcapsules are described below. The non-reactive components preferably are chemical compounds, and may include any one or more of the following adhesives, tackifiers, solvents, plasticizers, and waxes. Such materials can increase adhesion of the ink to the substrate, such as by softening, etching or dissolving the contacted surface of the substrate. These constituents can also add cohesiveness to the ink material making it less prone to flake away from the substrate. In one embodiment, waxes can particularly improve the scuff resistance of the ink material. Some adhesives that may be employed include pressure sensitive adhesives (PSA), such as but not limited to materials of acrylics, urethanes, hydrocarbons, vinyls, polyesters, rubber based materials, silicones, polyvinyl alcohols, ethylene vinyl acetate (EVA), styrene block copolymers (SBC), polyisobutylene, styrene/butadiene copolymers, vinyl toluene/butadiene copolymers, vinyl toluene/acrylate copolymers, styrene/acrylate copolymers and combinations thereof. Adhesives can improve the adhesion and cohesive properties of the ink.

Some examples of tackifiers may include materials such as but not limited to polyamides, polyester, silicones, aliphatic and aromatic hydrocarbons, rosin esters, other resins, rosins and hydrocarbons, terpenes, phenolics, polyester, other polymers and combinations thereof.

Some examples of solvents can include but are not limited to organic solvents such as ketones, esters, alcohols, glycols, acetates, hydrocarbons, and combinations thereof.

Some examples of waxes can include materials that are natural or synthetic, and/or combinations thereof. In general, tackifiers, solvents, and plasticizers improve adhesion on the ink to the printed substrate. A wax can provide additional enhancement in abrasion or mar resistance.

Some examples of reactive components enclosed in the microcapsules are described below. The reactive components preferably are chemical compounds, and may include any one or more of the following resins, crosslinkers, hardeners and catalysts. Reactive resins can provide, for example, sites for physical interactions such as hydrogen bonding or chemical reactions. Crosslinkers and hardners may be included as co-reactants for the reactive resins, in which they may take part in the reactions desired. A catalyst can help accelerate the reactions that enhance the ink properties such as scratch resistance, abrasion resistance, impact resistance, UV degradation resistance, and moisture and chemical resistance, and the like.

It will be appreciated that the term “resin” is meant to include natural and synthetic resins as wells as synthetic polymers, and may include both reactive and nonreactive types of each. As described, a crosslinker can be a material added to a reactive resin to aid in its reacting or crosslinking, while a catalyst can accelerate that reaction or crosslinking.

Some examples of resins may include but are not limited to carboxy-terminated polyester resins, hydroxyl-terminated polyester resins, alkyds, uralkyds, a natural resin such as congo, copal, dammar, and kauri, and may also include examples as ester gum, a phenolic material, rosin, epoxy, isocyanates, methacrylated oligomers, acrylated melamine-formaldehyde, acrylated monomers, thiolenecycloaliphatic epoxides, vinyl ethers, styrene, a cellulosic material, polyvinylalcohol, silicones, cyanoacrylates, styrene maleic anhydrides (SMAs).

Some examples of crosslinkers or hardeners may include but are not limited to epoxy resins, 2-hydroxyalkylamides, tetramethoxymethylglyceryl, polyaziridine, polycarbodiimide, isocyanates, blocked isocyanates, drying oils such as triglycerides, triesters of glycerol epoxy esters and fatty acids, aliphatic amines, phenols, polyisocyanates, amines, urea, carboxylic acids, alcohols, polyethers, urea-formaldehyde, melamines, aldehydes, salts of multi-valent anions.

Some examples of catalysts may include but are not limited to alcohols, phenols, weak acids, amines, metal salts, urethanes, chelates, organometallic materials, photoinitiators, free radical initiators, onium salts of strong acids.

It will be appreciated that such materials listed for the resin, crosslinker, and catalyst are merely exemplary, as other materials may be employed so as to be suitable in achieving a property enhancing feature of the ink material or interaction of the ink material with the substrate.

It further will be appreciated that the terms resin, crosslinker and catalyst may be used interchangeably based on the physical form and concentrations. For example, a resin is generally considered to be a relatively higher molecular weight compound or a polymeric compound. Generally a crosslinker or catalyst are low molecular weight compounds. However, a resin can be modified with an appropriate functional group to act like a catalyst or crosslinker. A hardner can be available as a low molecular weight compound or in polymeric form, which can act as a resin. In yet another example, the reactive compounds may further include one or more types of resins capable of reacting with each other without the use of any crosslinker or catalyst.

It further will be appreciated that any of the reactive components may be present inside the microcapsule and/or in the components outside the microcapsule, such as in the ink. As one example, reactive material(s) may be employed outside the microcapsules to be reacted with reactive material(s) inside microcapsules or in another layer, so as to keep the reactive materials separated until a reaction is desired. For instance, if an isocyanate were reacted with a polyol, the polyol can be part of the ink material and the isocyanate can be either encapsulated or be in a separate coating on top of or underneath the layer of ink material. In yet another example, non-reactive components may also be in the layer of ink material and there may also be additional non-reactive components in the release and/or adhesive layer, where appropriate.

It will be appreciated that reactive and non reactive materials may be present outside the microcapsules, as long as at least one reactive component and/or non-reactive component is in a microcapsule. In some embodiments, a second or third reactive component may be encapsulated, while some embodiments would not require the second reactive component to be encapsulated, and in other embodiments, a second reactive component would not be used at all.

In yet another embodiment, each reactive component used may be contained in separate microcapsules, such that the ink composition has different types of microcapsules. When a carrier is used, for example a substrate that is in the ribbon form, the different types of microcapsules may be present in a desired proportion and in a desired location within various layers of the ribbon. As will be illustrated herein, it will be appreciated that when a carrier is used, the microcapsules may be present in the ink layer, or in another layer, such as the adhesive layer or the release layer, or may be present in all three layers. Upon release, the reactive component(s) can react with each other and/or with the ink material to bring about the desired property enhancement.

Table 1 below provides some examples of combinations of resins, crosslinkers, and catalysts for the reactive chemical compounds that may reside in the microcapsules. It will be appreciated that these combinations are merely exemplary as other combinations may be employed as necessary for achieving the desired property enhancements. As described before, resin, crosslinker or catalyst terms may be used interchangeably.

TABLE 1

| Resin | Crosslinker | Catalyst |
|---|---|---|
| polyester resin (carboxy- | epoxy resins, 2-hydroxyalkylamides, | |
| terminated) | tetramethoxymethylglyceril, | |
| | polyaziridine, polycarbodiimide | |
| polyester resin (hydroxy- | Isocyanates, blocked isocyanates | |
| terminated) | | |
| alkyds | drying oils (triglycerides, triesters of | Metal compounds, |
| | glycerol epoxy esters and fatty | naphthanates |
| | acids) | |
| congo, copal, dammar, | | |
| kauri, ester gum, a | | |
| phenolic material, rosin | | |
| epoxy | aliphatic amines, phenols, | alcohols, phenol, |
| | polyisocyanates | weak acids |
| isocyanates | amines, urea, carboxylic acids, | amines, metal salts, |
| | alcohols, polyethers | urethanes, chelates, |
| | | an organometallic |
| | | material |
| methacrylated oligomers, | amines | photoinitiator |
| acrylated melamine- | | |
| formaldehyde | | |
| acrylated monomers | Multi functional acrylates | photoinitiator |
| thiolenecycloaliphatic | | onium salts of |
| epoxides, vinyl ethers, | | strong acids |
| styrene | | |
| a cellulosic material | urea-formaldehyde, melamines | |
| polyvinylalcohol | aldehydes, urea formaldehyde, salts | |
| | of multi-valent anions | |
| silicones, cyanoacrylates | | |
| SMA (styrene maleic | alcohols, amines | |
| anhydrides) | | |

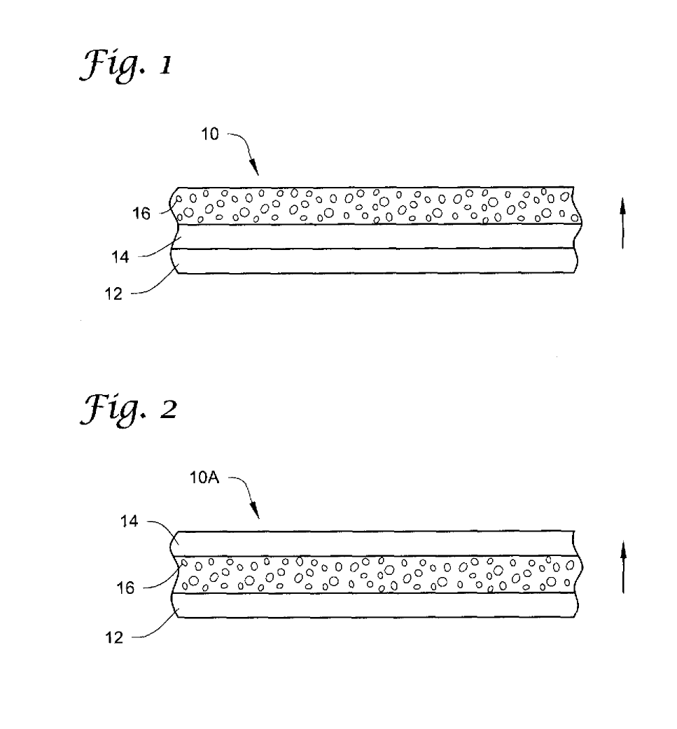

When a carrier is employed, for example a carrier in a ribbon form, the microcapsules may be located or disposed with respect to the ink material in a number of configurations. FIGS. 1-4 illustrate some exemplary configurations for various compositions of an ink material 14 and microcapsules 16 in various print ink materials. It will be appreciated that the print ink composition configurations described below, and namely the ink material 14, the microcapsules 16, and/or the carrier 12 may employ any of the concepts described above. It further will be appreciated that the microcapsules 16 may be dispersed in other components such as a resin or other additives in any particular layer of the print ink composition, such as in the exemplary configurations below.

FIG. 1 illustrates a print ink material 10. The print ink material 10 includes a composition having an ink material 14 and microcapsules 16, where the microcapsules 16 are located as a separate layer towards an outer side opposite a carrier 12. The ink material 14 and microcapsules 16 are configured to be printed on a suitable print substrate (e.g. identity document) in the direction of the arrow shown. A binder resin may be employed to keep the microcapsules 16 in their respective layer before release is desired. The ink material 14 is disposed in a separate layer between the layer of microcapsules 16 and carrier. The carrier 12 may be any suitable substrate, such as a ribbon material configured to support the layer of microcapsules 16 and layer of ink material 14 and other components that may be used in the composition.

FIG. 2 illustrates a print ink material 10A, which includes a composition showing the microcapsules 16 located as a separate layer towards the carrier 12 side. As shown, the microcapsules 16 are in a layer between the carrier 12 and the ink material 14. As with composition 10, a binder resin may be employed to keep the microcapsules 16 in the respective layer before release is desired. The carrier 12 supports the layer of microcapsules 16 and the layer of ink material 14 and other components that may be used in the composition. FIG. 2 shows the ink material 14 disposed in a separate layer towards an outer side opposite the carrier 12. The ink material 14 and microcapsules 16 are configured to be printed on a suitable print substrate (e.g. identity document) in the direction of the arrow shown.

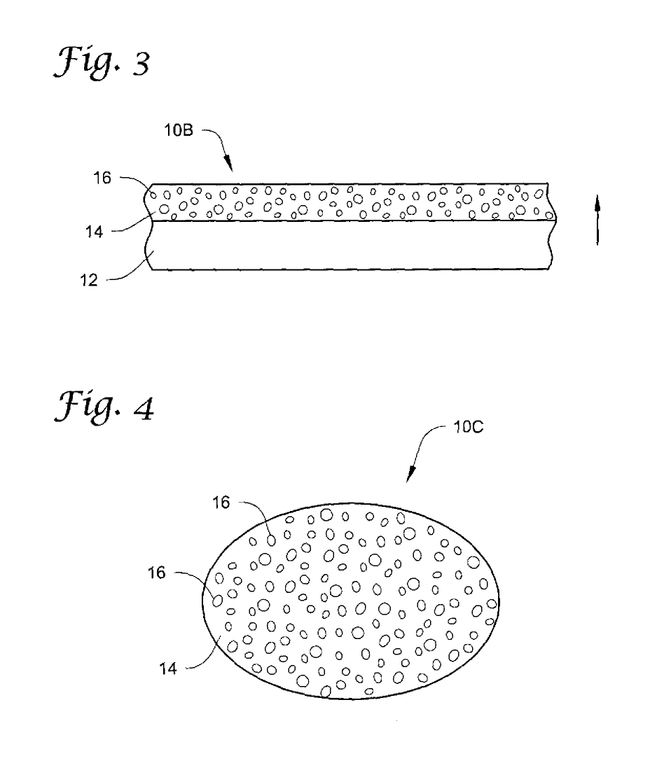

FIG. 3 illustrates a print ink material 10B, which includes a composition showing the microcapsules 16 and ink material 14 dispersed in the same layer. In this configuration, the microcapsules 16 and ink material 14 are mixed within the same layer. It will be appreciated, however, that the capsules remain intact such that release of the chemical compound(s) in the microcapsules does not occur until release is desired, such as after application of the print ink composition 10B. FIG. 3 shows a single layer of microcapsules 16 dispersed with ink material 14. It further will be appreciated that more than one layer may be used, in which each layer is a separate layer that includes microcapsules 16 dispersed with ink material 14. The ink material 14 and microcapsules 16 are configured to be printed on a suitable print substrate (e.g. identity document) in the direction of the arrow shown.

The arrows illustrated in FIGS. 1-3 indicate a direction in which the print ink compositions would face when the compositions are to be printed on a substrate. It will be appreciated that combinations of the configurations illustrated in FIGS. 1-3 above may be employed as suitable for achieving the desired property enhancement effect(s).

FIG. 4 illustrates yet another embodiment for a print ink composition 10C where the ink material 14 and microcapsules 16 are dispersed together or mixed, but without a carrier support. In such a configuration, the print ink composition 10C may be applied to a substrate by other delivery mechanisms than a traditional ribbon or film. Such delivery mechanisms may include but are not limited to for example, pressurized spray techniques, or ink jet, fluid delivery device, gravure printing, sponge or pad applicator, screen printing, brush application, spin coating, dip coating, etc. The print ink composition 10C may be stored in a container, and may be contained in a pressurized container. It will be appreciated that suitable velocities for spraying the print ink composition 10C onto the substrate (e.g. card) may be employed, so that the chemical compound(s) in the microcapsules 16 can be released on impact with the substrate. Other means such as but not limited to, heat, pressure, shear, impact, radiation etc. may also be employed to release the component(s) that are inside the capsules.

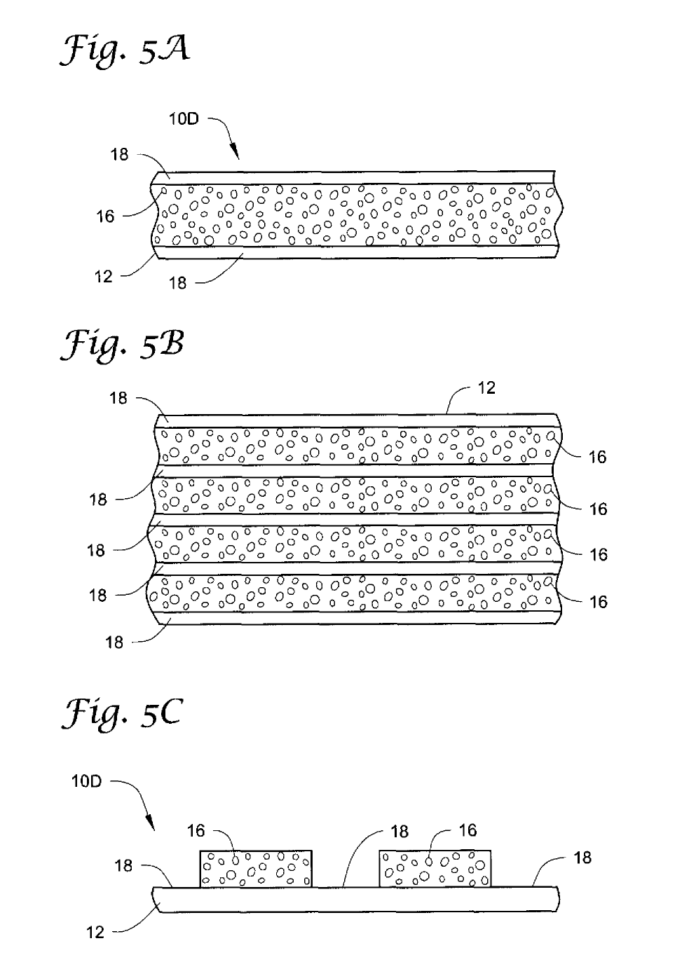

FIG. 5A illustrates a schematic view showing a width of yet another embodiment of a print ink material 10D. The print ink material 10D includes a print ink composition that is shown in a top view and supported by a carrier 12. As shown, the print ink material includes portions with the print ink composition, and includes portions 18 without the print ink composition supported. The portions 18 are “free” or “blank” areas of the carrier 12 that are not supporting any print ink composition. The portions 18 allow for regions of the carrier substrate to be cut so as not to disturb or break the microcapsules 16. In such a configuration, premature release of the chemical compound(s) residing in the microcapsules can be prevented, such as during manufacture operations of multiple print ink compositions, i.e. during slitting/converting operations, where the areas free of the ink material would be where the slitter knives would slit the embodiment.

This configuration can be especially beneficial during the manufacturing stage in which a larger width of print ink material can be produced with a number of print ink compositions on a wider area of carrier 12. As shown in FIG. 5B, for a larger width of print ink material, a plurality of portions 18 may separate a plurality of print ink compositions, so that multiple print ink compositions can be produced.

FIG. 5C illustrates a partial cross section of the print ink material 10D shown in FIG. 5B. FIGS. 5A and 5B shows the portions 18 may be strips of “free areas” extending along a length of the print ink material 10D. For exemplary purposes only, FIGS. 5A through 5B illustrate a top view and FIG. 5C is a cross sectional view where the microcapsules 16 are mixed with the ink composition 14 in a layer that would face the substrate the print ink composition is to be printed on and similar to the configuration of FIG. 3.

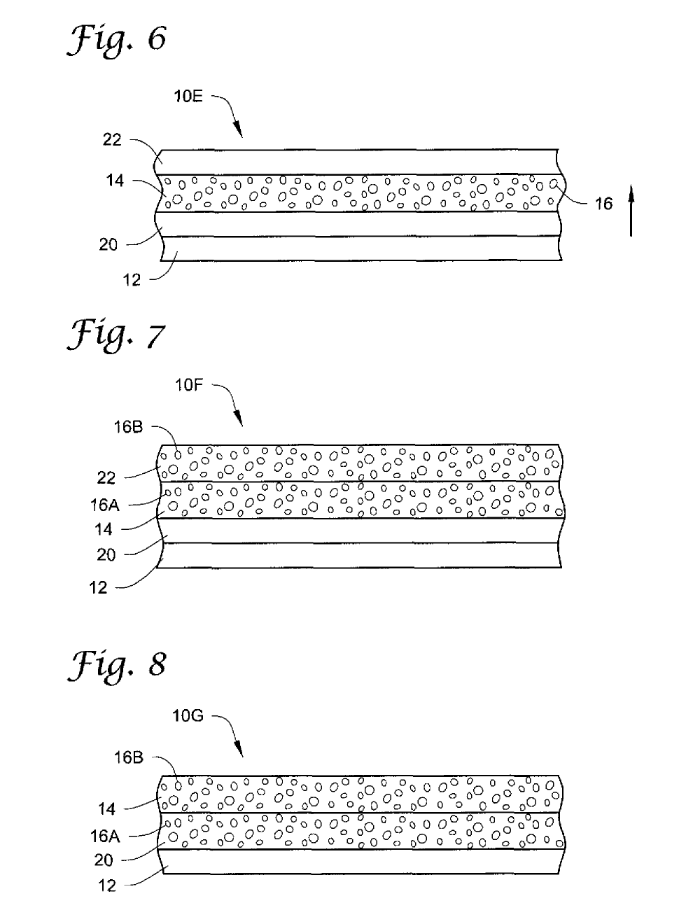

FIG. 6 illustrates a schematic cross-section view of yet another embodiment of a print ink material 10E having a print ink composition including an ink material 14 and microcapsules 16. The print ink material 10E also includes a release layer 20 and an adhesive layer 22. As one example, the release layer 20 is disposed between the carrier 12 and the composition of the ink material 14 and microcapsules 16. The release layer 20 is configured for facilitating release of the ink material 14 and microcapsules 16 from the carrier 12.

The adhesive layer 22 is disposed on an outer side of the composition of the ink material 14 and microcapsules 16 and opposite of the carrier 12. The adhesive layer 22 is configured so as to face a substrate that the print ink composition is to be printed or applied on. The adhesive layer 22 may further facilitate adherence of the print ink composition to the substrate (i.e. card). The arrow illustrated indicates a direction in which the print ink composition faces when printing of the print ink composition on the substrate is desired. FIG. 6 illustrates the layer configuration of the ink material 14 and microcapsules 16 similarly as FIG. 1. It will be appreciated, however, that any of the print ink composition configurations described in FIGS. 1-5C may also employ the release and adhesive layers.

FIGS. 7 and 8 respectively illustrate yet other embodiments, for print ink compositions 10F, 10G. FIG. 7 shows different microcapsules 16A and microcapsules 16B disposed in distinct layers of the composition 10G, and facing toward the outer most side away from the carrier 12. It will be appreciated that the layers in which the microcapsules 16A and 16B respectively reside may be interchanged as desired or necessary, and may be mixed together in each of the layers shown if desired or necessary. In one embodiment, the microcapsules 16B may be disposed in the adhesive layer 22 of the composition 10F, and the microcapsules 16A are disposed in the ink layer 14 of the composition 10F.

FIG. 8 shows different microcapsules 16A and microcapsules 16B disposed in distinct layers of the composition 10G, where microcapsules 16B face toward the outer most side away from the carrier 12 and microcapsules 16A are disposed in the layer between the carrier and the layer in which the microcapsules 16B are disposed. In one embodiment, the microcapsules 16A may be disposed in the release layer 20 of the composition 10G, and the microcapsules 16B are disposed in their own layer of the composition 10G. As with composition 10F, it will be appreciated that in composition 10G the layers in which the microcapsules 16A and 166B respectively reside may be interchanged as desired or necessary, and may be mixed together in each of the layers shown if desired or necessary.

It further will be appreciated that any of the configurations illustrated in FIGS. 1-3 and 6-8 may be suitably employed on a carrier with “free” or “blank” areas, as the portions 18 shown in FIGS. 5A through 5C. That is, any of the print ink composition in FIGS. 1-3 and 6-8 may be employed, by selectively applying one or more of the composition configurations of the ink material and microcapsules on a carrier in a non-continuous form.

The following are additional non-limiting examples of potential print ink compositions that may be employed for some of the configurations described in the Figures.

| Component | Wt. % |
|---|---|
| Tint-Ayd ® 317H | 35 |
| UCAR ™ VYLF | 8 |
| Slip-Ayd ® SL551 | 10 |
| DOP | 2 |
| methyl ethyl ketone | 45 |

Slip-Ayd ® is a registered trademark of Elementis Specialties, Inc.
Tint-Ayd ® is a registered trademark of Elementis Specialties, Inc.
UCAR ™ is a trademark for Union Carbide Chemicals and Plastics Company Inc.

### EXAMPLE A

### FIG. 1; Pressure-Sensitive Adhesive as the Property Enhancing Component

An ink material was prepared of the following composition:

The ink was deposited onto a 0.6 mil untreated polypropylene film and metered with a # 15 mayer rod. The ink was dried at 200° F. for 20 seconds and the embodiment was made ready for the adhesive coat.

An adhesive was prepared with the following composition:

| Component | Wt. % |
|---|---|
| Adcote ® 37R972 | 55 |
| Microencapsulated Gel-Tac ® Adhesive 216B | 45 |

Adcote ® is registered trademark of Morton International, Inc.
Gel-Tac ® is registered trademark of Advanced Polymers International

The above adhesive was deposited onto the ink coated film above and metered with a #10 mayer rod. The coated film was dried at 200° F. for 30 seconds and was ready for conversion into ribbon for the printing process.

### EXAMPLE B

### FIG. 3; Pressure-Sensitive Adhesive as the Property Enhancing Component

An ink was prepared of the following composition:

| Component | Wt. % |
|---|---|
| Tint-Ayd ® 317H | 25 |
| Elvacite ® 4036 | 8 |
| Wax Dispersion 40 | 10 |
| GELVA ® GMS RA1151 - Microencapsulated | 20 |
| DOP | 2 |
| xylene | 35 |

Elvacite ® is a registered trademark of Ineous Acrylics
GELVA ® is a registered trademark of Cytec Industries Inc.
Tint-Ayd ® is a registered trademark of Elementis Specialties, Inc.
UCAR ™ is a trademark for Union Carbide Chemicals and Plastics Company Inc.
Wax Dispersion 40 is commercialized by Michelman, Inc.

The ink was deposited onto a 0.6 mil untreated polypropylene film and metered with a #20 mayer rod. The ink was dried at 200° F. for 30 seconds and the embodiment was ready for conversion into print ribbon.

### EXAMPLE C

### FIG. 3: Air Drying Alkyd as the Property Enhancing Component

An ink was prepared of the following composition:

| Component | Wt. % |
|---|---|
| Black base BB 1355 | 25 |
| Wax Dispersion 141 | 10 |
| Additol XL6515- Microencapsulated | 5 |
| Cellolyn 95-80T | 10 |
| Aroplaz ® 1271 Linseed Oil - Microencapsulated | 10 |
| xylene | 40 |

Additol XL6515 is commercialized by Cytec Industries Inc.
Aroplaz ® is a registered trademark of Reichold Inc.
Black base BB 1355 is commercialized by Elementis Specialties, Inc.
Cellolyn is a trademark of Hercules Incorporated
Wax Dispersion 141 is commercialized by Michelman, Inc.

The ink was deposited onto a 0.6 mil untreated polypropylene film and metered with a #24 mayer rod. The ink was dried at 200° F. for 30 seconds and the embodiment was ready for conversion into print ribbon.

### EXAMPLE D

### FIG. 1; Tackifier as the Property Enhancing Component

An ink was prepared of the following composition:

| Component | Wt. % |
|---|---|
| carbon black Regal ® 400R | 8 |
| Elvacite 2008 | 10 |
| ethyl cellulose | 10 |
| Paraffin wax | 8 |
| Slip-Ayd 528 | 10 |
| Lard Oil WS | 4 |
| methyl ethyl ketone | 25 |
| toluene | 25 |

Lard Oil WS is commercialized by Atlas Refinery Inc.
Ethyl cellulose is commercialized by Hercules Incorporated
Regal ® is a registered trademark of Cabot Corporation

The ink was deposited onto a 0.6 mil untreated polypropylene film and metered with a #15 mayer rod. The ink was dried at 200° F. for 20 seconds and the embodiment was made ready for the adhesive coat.

An adhesive was prepared with the following composition:

| Component | Wt. % |
|---|---|
| Wax Dispersion 40 | 10 |
| Adtac ® LV - microencapsulated | 20 |
| mineral spirits | 35 |
| xylene | 35 |

Adcote ® is registered trademark of Morton International, Inc.
Gel-Tac ® is registered trademark of Advanced Polymers International

The above adhesive was deposited onto the ink coated film above and metered with a #10 mayer rod. The coated film was dried at 200° F. for 30 seconds and was ready for conversion into ribbon for the printing process.

### EXAMPLE E

### FIG. 6; Isocyanate as the Property Enhancing Component

An ink was prepared of the following composition:

| Component | Wt. % |
|---|---|
| Raven 1255 carbon black | 3 |
| CAP 482-0.5 | 9.5 |
| Slip-Ayd 528 | 3 |
| Pluracol ® PEP 450 | 7 |
| Desmodur N3200 - microencapsulated | 7 |
| Metacure ™ T-9 | 0.5 |
| methyl ethyl ketone | 35 |
| toluene | 35 |

CAP (cellulose acetate proprionate) is commercialized by Eastman Chemical Products, Inc.
Desmodur is a trademark of Bayer Corporation
Metacure ™ is a trademark of Air Products and Chemicals, Inc.
Pluracol ® is a trademark of BASF Corporation
Rayven is a trademark of Columbian Chemicals Company

The ink was deposited onto a 0.48 mil release coated polyester film (coat onto the release side of the film) by direct gravure using a 95 trihelical gravure cylinder. The ink was dried at 200° F. for 20 seconds and the embodiment was made ready for the adhesive coat.

An adhesive was prepared with the following composition:

| Component | Wt. % |
|---|---|
| Wax Dispersion 40 | 20 |
| xylene | 80 |

The above adhesive was deposited onto the ink coated film above using a direct gravure method and a 140 trihelical gravure cylinder. The coated film was dried at 200° F. for 30 seconds and was ready for conversion into ribbon for the printing process.

### EXAMPLE F

### FIG. 7; UV Monomer as the Property Enhancing Component in Ink Coat and Tackifier as Property Enhancing Component in the Adhesive Coat

An ink was prepared of the following composition:

| Component | Wt. % |
|---|---|
| Black base BB 1355 | 24 |
| Elvacite 2013 | 8 |
| Slip-Ayd 528 | 5 |
| Cyracure ® UVR-6105 - microencapsulated | 17 |
| Cyracure ® UVI-6974 | 1 |
| methyl ethyl ketone | 45 |

Cyracure is a registered trademark of Union Carbide Chemicals and Plastics Company Inc.

The ink was deposited onto a 0.48 mil release coated polyester film (coat onto the release side of the film) by direct gravure using a 95 trihelical gravure cylinder. The ink was dried at 200° F. for 20 seconds and the embodiment was made ready for the adhesive coat.

An adhesive was prepared with the following composition:

| Component | Wt. % |
|---|---|
| Wax Dispersion 40 | 20 |
| Adtac ® LV - microencapsulated | 20 |
| Mineral Spirits | 30 |
| xylene | 30 |

The above adhesive was deposited onto the ink coated film above using a direct gravure method and a 140 trihelical gravure cylinder. The coated film was dried at 200° F. for 30 seconds and was ready for conversion into ribbon for the printing process.

### EXAMPLE G

### FIG. 8, UV Monomer as the Property Enhancing Component in Release Coat and Another Property Enhancing Component in the Ink Coat

A release coating was prepared with the following composition:

| Component | Wt. % |
|---|---|
| Slip-Ayd SL-528 | 10 |
| Elvacite 2008 | 10 |
| (Sartomer SR-454 + 3% Irgacure 184) - microencapsulated | 20 |
| methyl ethyl ketone | 60 |

Sartomer SR-454 is commercialized by Sartomer Company, Inc.
Irgacure ® is a trademark of Ciba Specialty Chemicals Inc.

The above release coating was deposited onto 0.48 mil untreated polyester film using a direct gravure method and a 140 trihelical gravure cylinder.

An ink was prepared of the following composition:

| Component | Wt. % |
|---|---|
| Black base BB 1355 | 22 |
| Elvacite 2013 | 8 |
| Wax Dispersion 141 | 5 |
| Cyracure ® UVR-6105 - microencapsulated | 17 |
| Cyracure ® UVI-6974 | 2 |
| toluene | 45 |

The ink was deposited onto the release side of the above coated film by direct gravure using a 95 trihelical gravure cylinder. The ink was dried at 200° F. for 30 seconds and the embodiment was ready for converting into ribbon for the printing process.

### EXAMPLE H

### FIG. 4; UV Curable Resin as the Property Enhancing Component

An ink was prepared of the following composition:

| Component | Wt. % |
|---|---|
| Tint-Ayd ® 3047 yellow | 4.7 |
| Elvacite ® 4036 | 1.5 |
| Cyracure ® UVR-6105 - microencapsulated | 3.2 |
| Cyracure ® UVI-6974 | 0.6 |
| methyl ethyl ketone | 90.0 |

The ink is to be spray or ink jet deposited onto the substrate and then UV cured after drying and activating the microcapsules by an external means, i.e. heat, pressure, etc.

### EXAMPLE I

### FIG. 5; Pressure-Sensitive Adhesive as the Property Enhancing Component

An ink was prepared of the following composition:

| Component | Wt. % |
|---|---|
| Tint-Ayd ® 317H | 25 |
| Elvacite ® 4036 | 8 |
| Wax Dispersion 40 | 10 |
| GELVA ® GMS RA1151 - microencapsulated | 20 |
| DOP | 2 |
| xylene | 35 |

Elvacite ® is a registered trademark of Ineous Acrylics
GELVA ® is a registered trademark of Cytec Industries Inc.
Tint-Ayd ® is a registered trademark of Elementis Specialties, Inc.
UCAR ™ is a trademark for Union Carbide Chemicals and Plastics Company Inc.
Wax Dispersion 40 is commercialized by Michelman, Inc.

The ink was deposited onto a 0.6 mil untreated polypropylene film and metered with a 95 trihelical cylinder by a direct gravure coating process. The gravure cylinder was lane engraved so that there would be lanes of film without ink across the web. The ink was dried at 200° F. for 30 seconds and the embodiment was ready for conversion into print ribbon.

### EXAMPLE J

### FIG. 2; Epoxy as the Property Enhancing Component in Ink Coat and Tackifier as Property Enhancing Component in the Adhesive Coat

A microcapsule mixture was prepared with the following composition:

| Component | Wt. % |
|---|---|
| Versamine ® 900 - microencapsulated | 10.0 |
| D.E.H. ™ 36 Epoxy Curing Agent - microencapsulated | 1.5 |
| D.E.R. ™ 332 Liquid Epoxy Resin - micoencapsulated | 10.0 |
| Methyl ethyl ketone | 78.5 |

Versamine ® is a registered trademark of Cognis Corporation
D.E.H. Epoxy Curing Agents are commercialized by The DOW Chemical Company
D.E.R. Liquid Epoxy Resin is a trademark of The DOW Chemical Company

The above microcapsule mixture was deposited onto a 0.6 mil untreated polypropylene film using a direct gravure method and a 120 trihelical gravure cylinder.

An ink was prepared of the following composition:

| Component | Wt. % |
|---|---|
| Tint-Ayd ® 3047 yellow | 35 |
| Elvacite 2013 | 10 |
| Wax Dispersion 40 | 10 |
| methyl ethyl ketone | 45 |

Cyracure is a registered trademark of Union Carbide Chemicals and Plastics Company Inc.

The ink was deposited onto the above coated film on the coated side of the film by direct gravure using a 95 trihelical gravure cylinder. The ink was dried at 200° F. for 30 seconds and the embodiment was ready for conversion into ribbon for the printing process.

The print ink compositions and materials described are useful for a variety of print applications. One particular example in which the print ink compositions and materials are useful is in indent printing applications. Other print technologies that may make use of the described technology herein include, but are not limited to, thermal printing, impact printing, hot stamping, roller applications, emboss printing, ink jet printing, gravure printing, spray printing, sponge or pad printing and lamination printing. Such print ink compositions as described herein can be beneficial for applying ink to any substrate surface in which conventional inks may not adhere to as adequately or do not provide desirable properties after printing.

With regard to the foregoing description, it is to be understood that changes may be made in detail, especially in matters of the construction materials employed and the size, concentrations, and arrangement of the components without departing from the scope of the present invention. It is intended that the specification and depicted embodiments be considered exemplary only, and that the true scope and spirit of the invention being indicated by the broad meaning of the claims.

We claim:

1. A print ink composition comprising:
an ink material; and
a plurality of microcapsules dispersed with the ink material, the plurality of microcapsules including at least one selective property enhancing component present in the microcapsules, the at least one property enhancing component being at least one of a physically interactive component and a chemically reactive component,
wherein the property enhancing component configured to be released from the microcapsules during at least one of before printing of the print ink composition, during printing of the print ink composition, and after printing of the print ink composition.

2. The print ink composition of claim 1, wherein the at least one property enhancing component, when released, being configured to bring about at least one of a physical interaction and a chemical reaction at an ink-substrate interface, when the ink material is printed on a substrate, or bring about at least one of a physical interaction and a chemical reaction within the print ink composition, resulting in one or more enhanced properties, or bring about at least one of a physical interaction and a chemical reaction at the print ink surface, resulting in one or more enhanced properties.

3. The print ink composition of claim 1, wherein the at least one property enhancing component including any one or more of an improved characteristic of the ink material as adhesion, abrasion resistance, chemical resistance, moisture resistance, cohesive strength, visual quality, light fastness, tamper evidence and security.

4. The print ink composition of claim 1, wherein the property enhancing component comprises a plurality of property enhancing components present in the microcapsules in a configuration comprising one or more of the plurality of property enhancing components being present together in the same microcapsules, or the plurality of property enhancing components having one or more of the property enhancing components present in separate microcapsules from any of the other property enhancing components that are present.

5. The print ink composition of claim 1, wherein the at least one property enhancing component being configured to be released from the plurality of microcapsules by any one or more of impact, pressure, shear, heat, radiation, laser, and combinations thereof.

6. The print ink composition of claim 1, wherein the plurality of microcapsules configured to be preserved up to about 1 to 7 years.

7. The print ink composition of claim 1, wherein the microcapsules comprising a shell material composed of any one or more of an acrylic, polyamide, polyurethane, vinyl, acrylamide, urea-formaldehyde, epoxy, phenolics, polystyrene, polyurea, rosin, starch, gluten, cellulosic, gelatin, and combinations thereof.

8. The print ink composition of claim 1, wherein the plurality of microcapsules dispersed with the ink material comprises a concentration of microcapsules with respect to the ink material in a range of about 95% to about 1%.

9. The print ink composition of claim 1, wherein the physically interactive component comprises any one or more of an adhesive, tackifier, solvent, plasticizers, and waxes and combinations thereof, and the chemically reactive component comprises any one or more of a resin, crosslinker, hardener, catalyst, and combinations thereof where any these components may be present in pure form or as solution, dispersion, emulsion or as a mixture with other inert components.

10. The print ink composition of claim 1, wherein the ink material and plurality of microcapsules configured to be delivered to a substrate by any one or more techniques as pressurized spray, ink jet, fluid delivery device, gravure printing, screen printing, brush application, spin coating, dip coating, sponge or pad applicator.

11. A print ink material comprising:
a carrier; and
a print ink composition comprising:
an ink material; and
a plurality of microcapsules;
at least one of the ink material and the microcapsules disposed as a first layer on the carrier and the other of the ink material and the microcapsules disposed as a second layer on the first layer, or the ink material and the microcapsules together are disposed on the carrier as one layer;
the plurality of microcapsules including at least one selective property enhancing component present in the microcapsules, the at least one property enhancing component being at least one of a physically interactive component and a chemically reactive component,
the property enhancing component configured to be released from the microcapsules during at least one of before printing of the print ink composition, during printing of print ink composition, and after printing of the print ink composition;
wherein the ink material and the plurality of microcapsules configured to be released from the carrier during at least one of before printing of the print ink composition, during printing of the print ink composition, and after printing of the print ink composition.

12. The print ink material of claim 11, wherein the at least one property enhancing component, when released, being configured to bring about at least one of a physical interaction and a chemical reaction at an ink-substrate interface, when the ink material is printed on a substrate, or bring about at least one of a physical interaction and a chemical reaction within the print ink composition, resulting in one or more enhanced properties, or bring about at least one of a physical interaction and a chemical reaction at the print ink surface, resulting in one or more enhanced properties.

13. The print ink material of claim 11, wherein the property enhancing component comprises a plurality of property enhancing components present in the microcapsules in a configuration comprising one or more of the plurality of property enhancing components being present together in the same microcapsules, or the plurality of property enhancing components having one or more of the property enhancing components present in separate microcapsules from any of the other property enhancing components that are present.

14. The print ink material of claim 11, further comprising portions on the carrier in which the print ink composition is not disposed.

15. The print ink material of claim 14, wherein the portions are configured as strips alternating with portions of the carrier where the print ink composition is disposed.

16. A microcapsule for a print ink composition, comprising:
at least one selective property enhancing component present in the microcapsules, the at least one property enhancing component being at least one of a physically interactive component and a chemically reactive component,
wherein the property enhancing component configured to be released from the microcapsules during at least one of before printing of the print ink composition, during printing of the print ink composition, and after printing of the print ink composition.

17. A method of printing an ink composition on a substrate comprising:
facing a print ink composition toward a substrate, the print ink composition including an ink material and a plurality of microcapsules, the plurality of microcapsules including at least one property enhancing component;
applying the ink material and plurality of microcapsules on the substrate;
releasing the at least one property enhancing component from the plurality of microcapsules, such that the at least one property enhancing component configured to bring about at least one of a physical interaction and a chemical reaction at an ink-substrate interface, or bring about at least one of a physical interaction and a chemical reaction within the print ink composition, or at the print ink surface.

18. The method of claim 17, wherein releasing the at least one property enhancing component from the plurality of microcapsules comprises at least one of releasing the at least one property enhancing component from the plurality of microcapsules before application of the printing ink, during application of the print ink composition to the substrate, or after the print ink composition has been applied to the substrate.

19. The method of claim 17, wherein the step of releasing the at least one property enhancing component from the plurality of microcapsules comprises at least one of impact, pressure, shear, heat, radiation, laser, and combinations thereof.

20. The method of claim 17, further comprising preserving the print ink composition for up to 1 to 7 years prior to use.

21. The method of claim 17, wherein the substrate that the print ink composition is applied is a document comprising any one or more of identification documents, other documents that bear information unique to a document holder, and other documents bearing unique document information.
